(19) United States
(12) Patent Application Publication
(10) Pub. No.: US 2008/0174441 A1
(43) Pub. Date: Jul. 24, 2008

(54) Device For Detecting the Fall of a Body Into a Pool

(76) Inventors: Michel Durand, Carros (FR); Anthony Ginter, La Ciotat (FR)

Correspondence Address: MARSH, FISCHMANN & BREYFOGLE LLP, 3151 SOUTH VAUGHN WAY, SUITE 411, AURORA, CO, 80014, US

(21) Appl. No.: 11/909,419

(22) PCT Filed: Apr. 25, 2006
(86) PCT No.: PCT/FR2006/000919

§ 371 Date: Sep. 21, 2007

(51) Int. Cl. G08B 23/00

(52) U.S. Cl. 340/573.6

(57) ABSTRACT

The invention relates to a device for detecting a falling of a body into the water of a pool, comprising a probe (1), which is immersed in the pool (20) and designed for transmitting aquatic waves that propagate in the pool. The probe is connected to a compression chamber (8) designed for measuring variations in pressure caused by these aquatic waves. An electronic unit (4) is designed for receiving and interpreting electrical signals representative of variations in pressure that are measured in the compression chamber. This electronic unit is designed for storing the signals generated by the pool and for alternating the operating mode of the device between a calm mode, a disturbed mode, and an agitated mode according to the value of the amplitude and to the value of the frequency of the electrical signals generated by the pool.

The present invention relates to a device for detecting the fall of a body, in particular the fall of a child or an animal, into a pool such as a swimming pool. Such a device makes it possible to detect a body falling into a mass of water and to alert those nearby, by a siren, warning lights, or any other means able to attract attention, in order to allow a rapid rescue.

In fact, the drowning of young children is involved in numerous domestic accidents. Safety devices do exist, such as protection barriers surrounding the swimming pool with an access gate. However, it is necessary to close the gate properly again every time it is passed through. Moreover, children of approximately three years of age can manage to open such a gate while they are still very exposed to drowning.

Safety devices also exist such as shelters, covers or shutters covering the swimming pool like a dome. Such a device is however unsightly and requires a complex removal operation before use of the swimming pool.

The ideal solution for effectively preventing falls into the swimming pool while retaining easy access and a user-friendly character is to equip the swimming pool with a device for detecting falls of bodies into the pool.

Such detection devices exist and are marketed. For example, the Aquapremium™, Aquasensor™, SensorPremium, SensorSolar, SensorElite, SensorEspio or SensorDomo devices marketed by the Applicant make it possible to detect the fall of a body into the pool of a swimming pool and to alert those nearby.

The known devices for detecting falls are generally constituted by a probe submerged in the pool and connected to an above-water housing. The submerged probe is able to transmit aquatic waves which are propagated in the pool. By “aquatic waves” is meant any movement of the water in the pool whether on the surface (waves) or at depth (underwater waves). The aquatic waves can be transmitted to a compression chamber in the housing in order to measure the variations in pressure caused by said waves. On certain device models, the compression chamber can be constituted by the probe itself, filled with air. Any movement in the pool, and in particular the falling of a body, causes the formation of waves which lead to variations in pressure in the compression chamber of the fall detector. A sensor, for example of piezoelectric type, converts these variations in pressure to a voltage and an electronic card processes these signals in order to interpret whether they correspond to a fall. If appropriate, the electronic card controls the transmission of an emergency signal.

The known detection devices however have the drawback of being sensitive to external disturbances and are subject to untimely triggering, due to the fact that the electronic card interprets disturbance signals as a fall. Such disturbance signals can be due to the displacement of the robot cleaner, to the starting operation of filtration, but also to rain or to waves caused by the wind. These disturbances can cause an untimely triggering of the alarm, which becomes annoying for those nearby and can prompt them to switch off the device with the risk of non-detection of a real fall. Most of these disturbances can be eliminated by adjusting the sensitivity of the detector.

However, disturbances due to the wind can have a wave signature very close to that caused by the fall of a child. It is not possible to envisage reducing the sensitivity of detection of the device and accept the fall of a child weighing less than 10 kg sliding at a 30° slope, therefore with little penetration of the water inducing a weak signal, on the grounds that a fairly strong wind was blowing.

The abovementioned devices marketed by the Applicant comprise a signal-processing system for minimizing the disturbances due to the wind. Two identical sensors are mounted differentially, a first sensor measuring the variations in pressure in the compression chamber and a second sensor measuring only the disturbances caused by the wind blowing on the housing. The measurement of the second sensor is subtracted from the measurement of the first sensor by the electronic card in order to process only the signal originating from the pressure differences in the compression chamber. This solution makes it possible to eliminate the disturbances due to the wind blowing on the housing but not to differentiate between the waves in the pool due to the wind and the waves caused by a fall.

A need therefore exists to reduce the risks of untimely triggering of the detection device alarm due to the effect of the wind on the swimming pool while guaranteeing detection of a real fall into the pool.

To this end, the invention proposes adapting the behaviour of the detection device as a function of the disturbances generated by the wind. In fact, it is very rare for the wind to get up all of a sudden and blow in strong gusts having the signature of the fall of a body into the swimming pool. The signals caused by the movements of the water are therefore measured continuously and memorized in order to adapt the device's detection mode to the level of disturbance of the pool.

Moreover, swimming pools comprise more and more systems for measuring and controlling the quality of the water, such as the pH, the temperature of the water and salt electrolysis treatment for example. Each system for measuring and/or controlling the swimming pool water generally comprises its own probe, its own processing electronics and its own display or alert system. The multiplication of measurement and control systems represents a cost and a space requirement for the swimming pool user.

A need therefore also exists to reduce the number of independent measurement and control systems in a single swimming pool. To this end, the invention proposes an integration of all these systems into the fall detection device.

The invention relates more particularly to a device for detecting a fall of a body into a mass of water in a pool comprising:
a probe submerged in the pool and able to transmit aquatic waves being propagated in the pool;
an electronic unit able to receive and interprete electrical signals representative of variations in pressure caused by the aquatic waves picked up by the probe;
the electronic unit being able to memorize the signals generated by the pool and switch the operating mode of the device between different operating modes depending on the value of the amplitude and the value of the frequency of the memorized electrical signals generated by the pool.

According to embodiments, the device for detecting a fall into a pool comprises one or more of the following characteristics:
the signals generated by the pool are memorized over a given time interval;
the time interval is comprised between 10 and 60 seconds;
the electronic unit is able to interpret an electrical signal as corresponding to a fall when said electrical signal has an amplitude above a predetermined threshold and a frequency approximately equal to 1 Hz;
the electronic unit is able to control the triggering of a sound alarm when the electrical signal received has a predetermined number of half-waves exceeding said amplitude;
the electronic unit is able to switch the operating mode of the device between a so-called calm mode, a so-called disturbed mode and a so-called agitated mode according to the value of the amplitude and the value of the frequency of the memorized electrical signals generated by the pool;
in so-called normal mode, the electronic unit triggers an alarm after detection of three half-waves;
in so-called disturbed mode, the electronic unit triggers an alarm after detection of five half-waves;
in so-called agitated mode, the electronic unit neutralizes the triggering of the sound alarm;
the electronic unit is able to trigger a sound and/or visual signal indicative of the changeover to so-called agitated mode;
the device has an indicator showing the current operating mode;
the electronic unit is able to receive data measured by a remote anemometer;
the device is able to maintain a measurement monitoring the aquatic waves in the pools during a so-called deactivated mode, the electronic unit being able to determine the most appropriate operating mode during the reactivation of the device as a function of the last memorized signals generated by the pool;
the device also comprises at least one probe for measuring the state of the water which is submerged in the pool and connected to the electronic unit;
the probe measuring the state of the water is chosen from a temperature probe, a pH-measuring probe, an electrolysis probe, a chlorine probe;
the device is connected to a pool management unit which is able to interpret the measurement signals relating to the state of the water.

The invention also relates to a method for detecting a fall of a body into a mass of water in a pool, comprising steps consisting of:
measuring aquatic waves being propagated in the pool;
converting the variations in pressure caused by said aquatic waves into electrical signals;
memorizing said signals generated by the pool;
switching the detection mode between different operating modes depending on the value of the amplitude and the value of the frequency of the memorized electrical signals.

According to embodiments, the detection method according to the invention comprises one or more of the following characteristics:
a step consisting of interpreting the electrical signal generated by the pool as corresponding to a fall when said electrical signal has an amplitude above a predetermined threshold and a frequency approximately equal to 1 Hz.
a step consisting of triggering a sound alarm when the electrical signal received includes a predetermined number of half-waves exceeding said amplitude;
switching one detection mode with the other when the number of electrical signals received with an amplitude above a predetermined threshold exceeds a predetermined value over a given time interval;
steps consisting of maintaining a monitoring measurement of the aquatic waves in the pool during a so-called deactivated mode and choosing the most appropriate detection mode upon reactivation of the device as a function of the last memorized signals generated by the pool;
a step consisting of automatically reactivating the fall detection when the device detects a calm or slightly disturbed state of the pool from the signals generated by the pool;
steps consisting of receiving data measured by a remote anemometer and choosing the most appropriate detection mode as a function of said received data;
steps consisting of measuring at least one parameter of the state of the water by a submerged probe and transmitting the measured value of the parameter of the state of the water to a management unit;
a step consisting of controlling a device for treatment of the water in the pool as a function of the value of the measured parameter of the state of the water; the measured parameter of the state of the water is chosen from a temperature, a pH, a chlorine level, an electrolysis salt concentration.

The characteristics and advantages of the present invention will become apparent from the following description given by way of an illustrative and non-limitative example and referring to the figures which show:

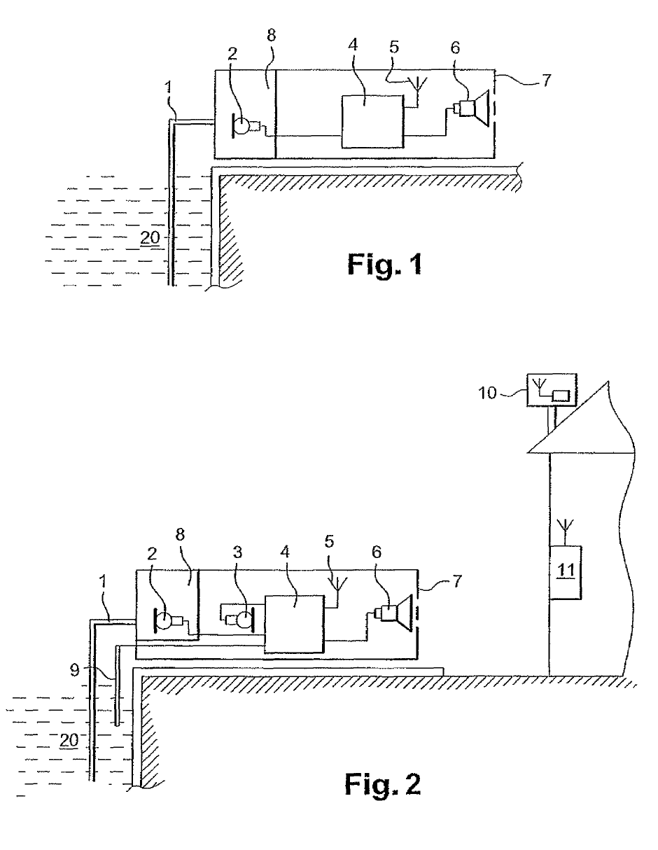

FIG. 1, a diagram of a fall detection device according to the invention;

FIG. 2, a diagram of a fall detection device [according to] an embodiment variant of the invention;

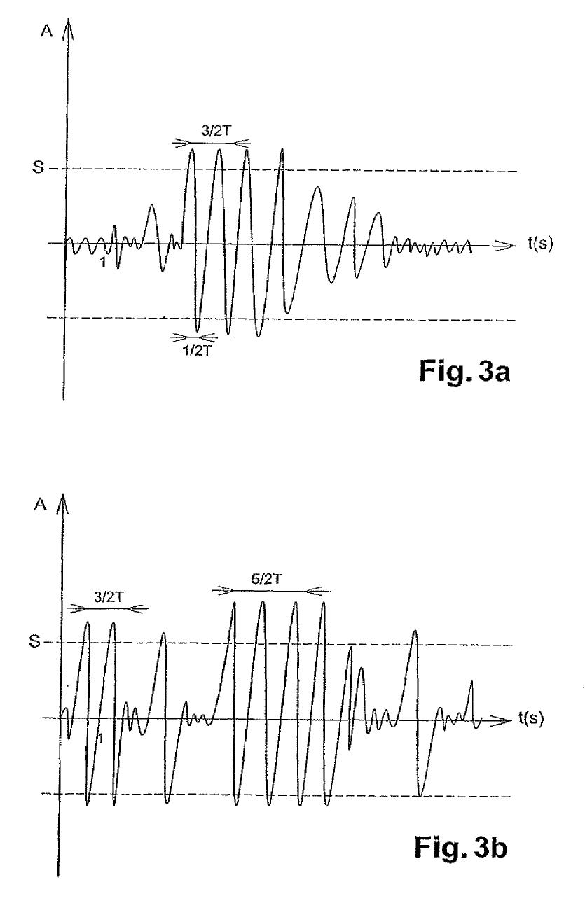

FIG. 3a, a graph illustrating the electrical signals generated in a pool in calm mode;

FIG. 3b, a graph illustrating the electrical signals generated in a pool in disturbed mode.

Within the scope of the invention, the expression “signals generated by the pool” is used in order to designate the electrical signals representative of the aquatic waves (waves and underwater movements) being propagated in the pool and received by the electronic card of the fall detection device via the submerged probe.

Within the scope of the invention, different operating modes of the fall detection device are also defined corresponding respectively to different states of agitation of the pool. In the following description, reference is made to three operating modes corresponding to three states of agitation of the pool. It is understood that the invention applies just as well to two different operating modes as to more than three modes.

A so-called calm mode is thus defined as a state of the pool slightly affected by the wind and in which the signals generated by the pool in the absence of a fall are of low amplitude and random frequency.

A so-called disturbed mode is also defined as a state of the pool which is partially agitated, in particular by the wind, and in which the electrical signals generated by the pool in the absence of a fall can be of high amplitude and constant and non-constant frequency over a few periods of time.

A so-called agitated mode such as a state of the pool which is vigorously agitated, in particular by the wind and in which the electrical signals generated by the pool in the absence of a fall can have an amplitude and a frequency similar to those of a fall of a body, in particular that of a young child, is finally defined. In this state, the pool is too agitated to allow discriminatory fall detection.

FIG. 1 describes a detection device according to the invention;

FIG. 1 shows a detection device arranged on the side of a pool 20, such as a swimming pool for domestic use for example. A probe 1 is submerged in the water in the pool and emerges into a compression chamber 8 arranged in a part of the housing 7 of the detection device. The compression chamber could be directly constituted by the submerged probe itself filled with air and serving as a compression chamber. The probe 1 can be a tube having a submerged free end and an end emerging into the housing 7 of the above-water detection device. The tube 1 is thus able to transmit the aquatic waves which are propagated in the pool 20 towards the compression chamber 8. This chamber is hermetically sealed and detects the aquatic waves coming up from the tube 1 as variations in pressure. A pressure sensor 2, for example of the piezoelectric type, is arranged in the compression chamber 8 in order to convert the variations in pressure into electrical signals. The pressure sensor 2 is connected to an electronic unit 4 arranged in the housing 7 of the detection device, outside the compression chamber 8.

The electronic unit 4 is able to receive and interpret the signals originating from the pressure sensor 2, i.e. the electrical signals representative of the variations in pressure in the compression chamber, therefore representative of the aquatic waves being propagated in the pool. Hereafter the expression “signals generated by the pool” is used to designate the electrical signals transmitted by the sensor 2 to the electronic unit 4.

The electronic unit 4 is able to interpret the signals generated by the pool in that it can in particular correlate values of amplitude and electrical signal frequency with a state of agitation of the pool and/or with a fall detection, as explained in more detail below. The electronic unit can include a microcontroller, in a manner known per se.

The electronic unit 4 is also able to memorize the signals generated by the pool. The electronic unit can include a memory chip, of RAM or EPROM type for example. The storage of the electrical signals by the electronic unit makes it possible to monitor the development of the disturbance of the pool and adapt the behaviour of the detection device as a function of the state of agitation of the water in the pool. The electronic unit memorizes in a loop the signals generated by the pool over a predetermined time interval, for example of the order of 10 to 60 seconds. This interval is sufficient to detect the development of the disturbance generated by the wind, without however requiring a large memory and significant software processing time.

The electronic unit 4 is thus able to alternate the operating mode of the device between different operating modes and in particular between a so-called calm mode, a so-called disturbed mode and a so-called agitated mode. The different operating modes are determined as a function of the values of amplitude and electrical signal frequency memorized, in particular over the last given time interval. The switching of the operating modes makes it possible to adapt the behaviour of the detection device in the context of the pool and to ensure optimum fall detection even in the case of wind agitating the pool.

In a general manner, the electronic unit is able to interpret an electrical signal received from the pressure sensor 2 as corresponding to a fall when said electrical signal is a sine wave having an amplitude above a predetermined threshold S with a frequency close to 1 Hz. Such a signal is in fact characteristic of a fall of a body into the water. The electronic unit is then able to control the triggering of a sound alarm 6 arranged in the housing 7 for example. The electronic unit can also trigger the transmission of an emergency signal by a radio transmitter 5 towards a remote siren, for example in the house.

As indicated previously, a wind blowing in strong gusts can cause aquatic waves having the same signature as the fall of a young child, i.e. a sinusoidal signal having an amplitude above the predetermined threshold S with a frequency close to 1 Hz. In order to avoid the untimely triggering of the sound alarm, and the temptation to completely deactivate the detection device in the case of strong wind with the risk of non-detection of a real fall which this involves, the invention proposes adapting the operating mode of the detection device to the climatological context and in particular to the development of the agitation of the pool measured and memorized by the electronic unit.

Thus a first threshold S is defined, corresponding to a predetermined amplitude of the signal generated by the pool beyond which the electronic unit counts the signal as a so-called valid item of information for the detection of a fall.

A second threshold S′ is also defined, below the first threshold S, corresponding to a predetermined amplitude of the signal generated by the pool beyond which the electronic unit counts the signal as an item of information capable of causing the detection device to change over from a so-called calm mode to a so-called disturbed mode and/or from a so-called disturbed mode to a so-called agitated mode.

The interpretation of the signals received by the electronic unit for the fall detection and the switching of the operating modes is described with reference to the graphs of FIGS. 3a and 3b.

The graph in FIG. 3a illustrates the electrical signal which can be received by the electronic unit in a so-called calm operating mode.

In calm mode, the wind does not disturb the measurement of the aquatic waves. The electronic unit perceives electrical signals of low amplitude, well below the predefined thresholds and with a random period. A weak wind in fact generates aperiodic and erratic signals when ripples are propagated on the surface of the pool.

In this context of operating in calm mode, a regular sinusoidal signal having an amplitude above the first predetermined threshold S with a frequency close to 1 Hz will therefore necessarily be the signature of a fall. This sinusoidal signal is in a standard fashion quantified as a half-wave ½T, a half-wave corresponding to a half period of the sinusoidal signal the peak of which exceeds the predetermined amplitude threshold.

Thus, when the electronic unit receives an electrical signal from the pressure sensor the amplitude of which exceeds said predetermined threshold S, it counts this event as a valid item of information. If it detects, in a predefined frequency range around 1 Hz, a certain number of valid items of information which are successive and not missing, it interprets this as a fall.

The electronic unit 4 then triggers the sound alarm 6 when the electrical signal received includes a predetermined number of half-waves ½T exceeding said amplitude threshold S. In so-called calm mode, the electronic unit triggers the alarm after detection of three half-waves 3/2T for example.

The graph in FIG. 3b illustrates the electrical signal which can be received by the electronic unit in disturbed mode operation.

In disturbed mode, the wind generates aperiodic and erratic signals which can reach a high amplitude, exceeding the first predetermined threshold S. In particular, when the wind generates underwater waves which strike the edges of the pool, a regular sinusoidal signal over a few periods having an amplitude above the predetermined threshold S with a frequency close to 1 Hz can be read by the electronic unit.

However, the electronic unit will have previously counted signals exceeding the second predetermined amplitude threshold S′ over the memorized preceding time intervals and will have caused the detection device to change over from the so-called calm mode to the so-called disturbed operating mode. For example, when more than two signals exceed the second amplitude threshold S′ over the last time interval memorized in the electronic unit, the electronic unit interprets this as a wind getting up and disturbing the pool and causes the device to change over into so-called disturbed operating mode.

In this context of operating in disturbed mode, a regular sinusoidal signal having an amplitude above the first predetermined threshold S with a frequency close to 1 Hz will not necessarily be the signature of a fall. In order to distinguish the signature of a fall from the signals generated by the wind on the pool in disturbed mode, the electronic unit 4 triggers the sound alarm 6 only when the electrical signal received includes five half-waves 5/2T as against three half-waves in the so-called calm operating mode.

In fact, as illustrated in FIG. 3b, the detection of three half-waves 3/2T can only be a wave signature due to the wind; on the other hand, it is extremely rare for five half-waves 5/2T to be a signature of waves due to the wind. Thus, when the electronic unit detects five valid items of information which are successive and not missing in so-called disturbed mode, it interprets this as a fall.

It should be noted that the sensitivity of the device remains the same whatever the operating mode; only the electronic processing, namely the counting of the half waves, is the element differentiating between the so-called calm mode and the so-called disturbed mode. This differentiation however makes it possible to significantly reduce the untimely triggering of the alarm.

In agitated mode, the pool can generated electrical signals having successions of half-waves with an amplitude above the first predetermined threshold S with a virtually regular frequency close to 1 Hz. The electronic unit is then no longer able to distinguish the signals due to a fall from the signals due to the wind. However, due to the storage of the preceding signals over given time intervals, and in particular of the number of signals having an amplitude exceeding the second predetermined threshold S′ over the last memorized time interval, the electronic unit will have caused the detection device to change over to agitated mode.

In particular, the electronic unit 4 neutralizes the triggering of the sound alarm 6, but does not however stop receiving the aquatic wave measurements provided by the pressure sensor 2.

Thus, as soon as the force of the wind reduces and the measured disturbances weaken, the electronic unit is able to cause the detection device to change over to disturbed mode, then to calm mode and re-establish the possibility of triggering the sound alarm. Thresholds different from the second threshold S′ can be chosen for reverse switching from the agitated mode to the disturbed mode and from the disturbed mode to the calm mode.

In agitated mode, the neutralization of the alarm makes it possible to avoid untimely triggering without however switching off the device. The device does not interrupt its detection and automatically re-establishes the triggering of the alarm when the detection conditions allow. It can be advantageous to provide the triggering of a sound signal indicating that the detection device has changed over to so-called agitated mode. For example, the electronic unit 4 can trigger the transmission of one or more sound beeps in order to warn those nearby that the sound alarm 6 is deactivated for a certain time or that it has changed mode.

Similarly, when the device is deactivated, for example when the users are bathing, the device according to the invention maintains a monitoring measurement of the aquatic waves in the pool during this so-called deactivated mode. Thus, when the device is reactivated, at the end of bathing, the electronic unit is able to choose the most appropriate detection mode—calm, disturbed or agitated mode—as a function of the last memorized signals generated by the pool.

According to an embodiment, the device is able to automatically re-establish an appropriate detection mode if the users neglect to reactivate the device after bathing. Detection can be re-established automatically after a simple delay time or when the device detects a calm or weakly disturbed state of the pool from the signals generated by the pool.

The fall detection device therefore makes it possible to improve safety by adapting its operating mode to the state of agitation of the pool and by maintaining detection in spite of the deactivation of the sound alarm, in agitated or deactivated mode, in order to be able to re-establish appropriate detection as soon as possible.

It can moreover be envisaged that the detection device according to the invention has an indicator showing the current operating mode, for example one or more light emitting diodes lit up alternately according to the operating mode of the device or a screen displaying the current operating mode on the device, or sound signals indicating the different modes or the switching from one to the other. The indications of the current operating mode can also be displayed on a remote detection unit, for example in the house, the items of information relative to the operating mode being transmitted by the electronic unit via the antenna 5 or any other appropriate telecommunication link.

According to an embodiment, the electronic unit 4 can receive items of information relative to the wind force in order to complete the items of information detected in situ in the pool by counting the waves exceeding predetermined thresholds. For example, the electronic unit 4 can receive data measured by a remote anemometer 10, illustrated in FIG. 2. The anemometer 10 can be placed on the roof of the house or at any other appropriate point having good reception to wind. The anemometer 10 can transmit its measurements to the electronic unit 4 of the detection device by a radio link via the antenna 5 or by any other appropriate telecommunication link.

FIG. 2 illustrates an embodiment variant of the device for detecting a fall according to the invention. In FIG. 2, the elements identical to those in FIG. 1 are designated by the same reference numbers. FIG. 2 thus shows a probe 1 submerged in the water in the pool 20 and connected to a compression chamber 8 arranged in a housing 7 of the detection device. A first pressure sensor 2 is arranged in the compression chamber 8 and a second sensor 3, identical to the first, can be placed in the housing 7, the two sensors being connected to a electronic unit 4 which is able to control a sound alarm 6. The second sensor 3 can be used in order to subtract the effects of the wind on the housing 7 from the measurement provided by the first sensor 2, as described with reference to the prior art.

FIG. 2 also shows another probe 9 submerged in the water in the pool. This other probe 9 is intended to provide a measurement of the state of the water in the pool 20. The measurements of the probe 9 are converted into electrical signals transmitted to the electronic unit 4. The probe 9 can be a temperature probe, a pH measurement probe or an electrolysis probe for example. It is understood that there can be several probes 9 immersed in the water in the pool and providing different measurements to the electronic unit.

According to an embodiment, the electronic unit 4 is able to memorize and interpret the signals provided by the probe 9 which measures the state of the water and displays results on a visual display unit provided on the housing 7 of the device. In particular, the temperature measurement can be displayed on the housing 7 of the device, close to the pool.

The electronic unit 4 can also transmit the results of the measurements of the state of the water to a remote management unit 1 1, for example in the house. The users can then take the necessary actions depending on the results displayed, for example add chlorine, adjust the PH, adjust the salt electrolysis, adjust the temperature of the water.

According to another embodiment, the electronic unit only receives the data measured by the probe 9 which measures the state of the water in the pool and transmits these measurements to a remote management unit 11, via the antenna 5 for example. It is then the management unit 11 which is able to interpret the measurement signals relating to the state of the water. The management unit 11 can simply display the result of the measurements in order to allow the users to take the appropriate actions or directly and automatically control a device for treating the water in the pool. For example, the management unit 11 can be adapted to control one or more dosing pumps or regulating systems in order to re-establish a correct pH or chlorine value, to initiate salt electrolysis or also regulate the temperature of the water. If the installation allows, the management unit 11 can also trigger the power supply to a heater or heat pump in order to heat the water in the pool or also switch on the pool illumination via the measurement of an appropriate light sensor.

Of course, the embodiments described previously can be combined together. In particular, the distribution of the processing and control between the electronic unit 4 of the detection device and the management unit 11 of the pool depends on the installations and can be duplicated.

Moreover, it is possible to envisage having a device for management of the state of the water in the pool which is separate from a fall detection device according to the invention. Such a device for management of the state of the water in the pool would nevertheless integrate all the probes for measuring the state of the water and would limit the number of autonomous control devices.

Of course, the present invention is not limited to the embodiments described by way of example. In particular, the software processing for determining the changeover from one operating mode to another can be based on a combination of predetermined amplitude and predetermined frequency thresholds and/or a range of amplitude and/or frequency thresholds.

1. Device for detecting a fall of a body into the water of a pool comprising:
a probe submerged in the pool and able to transmit aquatic waves being propagated in the pool;
an electronic unit able to receive and interpret electrical signals representative of variations in pressure caused by the aquatic waves picked up by the probe;
the electronic unit being able to memorize the signals generated by the poo and switch the operating mode of the device between different operating modes according to the value of the amplitude and the value of the frequency of the memorized electrical signals generated by the pool.

2. Detection device according to claim 1, characterized in that the signals generated by the pool are memorized for a given time interval.

3. Detection device according to claim 2, characterized in that the time interval is comprised between 10 and 60 seconds.

4. Detection device according to claim 1, characterized in that the electronic unit is able to interpret an electrical signal as corresponding to a fall when said electrical signal has an amplitude above a predetermined threshold (S) and a frequency (1/T) approximately equal to 1 Hz.

5. Detection device according to claim 4, characterized in that the electronic unit is able to control the triggering of a sound alarm when the electrical signal received has a predetermined number of half-waves (½T) exceeding said amplitude (S).

6. Detection device according to claim 1, characterized in that the electronic unit is able to switch the operating mode of the device between a so-called calm mode, a so-called disturbed mode and a so-called agitated mode according to the value of the amplitude and the value of the frequency of the memorized electrical signals generated by the pool

7. Detection device according to claim 6, characterized in that, in so-called calm mode, the electronic unit triggers an alarm after the detection of three half-waves ( 3/2T).

8. Detection device according to claim 6, characterized in that, in so-called disturbed mode, the electronic unit triggers an alarm after detection of five half-waves ( 5/2T).

9. Detection device according to claim 6, characterized in that, in so-called agitated mode, the electronic unit neutralizes the triggering of the sound alarm.

10. Detection device according to claim 6, characterized in that the electronic unit is able to trigger a sound and/or visual signal indicative of changeover to so-called agitated mode.

11. Detection device according to claim 1, characterized in that it has an indicator showing current operating mode.

12. Detection device according to claim 1, characterized in that the electronic unit is able to receive data measured by a remote anemometer.

13. Detection device according to claim 1, characterized in that it is able to maintain a monitoring measurement of the aquatic waves in the pool during a so-called deactivated mode, the electronic unit being able to determine the most appropriate operating mode during the reactivation of the device as a function of the last memorized signals generated by the pool.

14. Device for detecting a fall of a body into the water of a pool comprising:
a first probe submerged in the pool and able to transmit aquatic waves being propagated in the pool;
a second probe for measuring the state of the water;
an electronic unit able to receive and interpret electrical signals representative of variations in pressure caused by the aquatic waves picked up by the first probe, the electronic unit being further able to receive and interpret electrical signals from the second probe,
the electronic unit being able to memorize the signals generated by the pool and switch the operating mode of the device between different operating modes according to the value of the frequency of the memorized electrical signals generated by the pool.

15. Detection device according to claim 14, characterized in that the second probe for measuring the state of the water is chosen from a temperature probe, a pH measurement probe, an electrolysis probe, or a chlorine probe.

16. Detection device according to claim 14, characterized in that it is connected to a management unit of the pool which is able to interpret the measurement signals relating to the state of the water.

17. Method for detecting a fall of a body into the water of a pool comprising steps consisting of:
measuring the aquatic waves being propagated in the pool;
converting the variations in pressure caused by said aquatic waves into electrical signals;
storing said signals generated by the pool;
switching the detection mode between different operating modes according to the value of the amplitude and the value of the frequency of the memorized electrical signals.

18. Detection method according to claim 17, also comprising a step consisting of interpreting the electrical signal generated by the pool as corresponding to a fall when said electrical signal has an amplitude above a predetermined threshold (S) and a frequency (1/T) approximately equal to 1 Hz.

19. Detection method according to claim 18, also comprising a step consisting of triggering a sound alarm when the electrical signal received includes a predetermined number of half-waves (½T) exceeding said amplitude (S).

20. Detection method according to claim 17, characterized in that one detection mode is switched with the other when the number of electrical signals received with an amplitude above a predetermined threshold (S′) exceeds a predetermined value over a given time interval.

21. Detection method according to claim 17, comprising steps consisting of:
maintaining a monitoring measurement of the aquatic waves in the pool during a so-called deactivated mode;
choosing the most appropriate detection mode during the reactivation of the device as a function of the last memorized signals generated by the pool.

22. Detection method according to claim 21, comprising a step consisting of automatically reactivating the fall detection when the device detects a calm or weakly disturbed state of the pool from the signals generated by the pool.

23. Detection method according to claim 17, comprising steps consisting of:
receiving data measured by a remote anemometer;
choosing the most appropriate detection mode as a function of said received data.

24. Detection method according to claim 17, comprising steps consisting of:
measuring at least one parameter of the state of the water by a submerged probe;
transmitting the measured value of the parameter of the state of the water to a management unit.

25. Detection method according to claim 24, comprising a step consisting of controlling a device for treatment of the water in the pool as a function of the value of the measured parameter of the state of the water.

26. Detection method according to claim 24, characterized in that the measured parameter of the state of the water is chosen from a temperature, a pH, a chlorine level, an electrolysis salt concentration.
